(19) United States
(12) Patent Application Publication
(10) Pub. No.: US 2013/0325589 A1
(43) Pub. Date: Dec. 5, 2013

(54) USING ADVERTISING CAMPAIGN ALLOCATION OPTIMIZATION RESULTS TO CALCULATE BIDS

(71) Applicant: Patrick R. Jordan, Mountain View, CA (US)

(72) Inventor: Patrick R. Jordan, Mountain View, CA (US)

(21) Appl. No.: 13/483,948

(22) Filed: May 30, 2012

(51) Int. Cl. G06Q 30/02

(52) U.S. Cl. 705/14.43

(57) ABSTRACT

A method, system, and computer program product for using advertising campaign allocation optimization results to calculate bids. The method commences by receiving a candidate impression opportunity corresponding to an advertising campaign that has both branding objectives and performance-based objectives. Contracts that can be satisfied by serving the candidate impression opportunity use advertising campaign allocation optimization results to determine a set of matching contracts. Given the matching contracts, the method continues to calculate bids for those matching contracts, then selects a target contract from among the matching contracts. The method then bids on the candidate impression opportunity using the calculated bid of the selected target contract. The method optimizes for overall campaign performance even when the campaign includes both branding campaign objectives and performance-based campaign objectives. The method tallies fulfillment when the calculated bid is the winning bid, and the campaign allocation optimization results are re-calculated in readiness for another placement.

### FIELD

The present disclosure is directed towards using advertising campaign allocation optimization results to calculate bids.

### BACKGROUND

In a legacy model, advertisers establish a relationship with an ad agency, and the advertiser communicates to the ad agency aspects of the advertiser's ad campaigns, including a budget for the campaign, the duration of the campaign, branding goals (e.g., number of viewers of placed ads) and performance goals (e.g., increase in revenue for the advertised product or service). Based on the campaign characteristics expressed by the advertiser, the ad agency constructs an advertising campaign, and prosecutes the ad campaign for the campaign duration. At the conclusion of the campaign, the ad agency and the advertiser might conduct a campaign review, and reach some conclusions as to the effectiveness of the campaign.

Unfortunately, it is possible that the conditions present (e.g., cost of ad placement, audience demographics, etc.) near the beginning of the campaign (e.g., when the ad campaign is being constructed) can change during the course of the campaign, sometimes significantly, thus possibly rendering some characteristics of the ad campaign ineffective. Following the legacy model, corrective action regarding the campaign cannot be taken until the campaign period is over, even though it might have been possible that changes in conditions could have been known, even during the course of prosecution of the ad campaign.

This situation is exacerbated in the context of internet advertising. That is, the conditions present during prosecution of an ad campaign can change day by day or even moment by moment. And, in the context of internet advertising (quite different from traditional media advertising) the opportunity for placement of an ad (aka an impression opportunity), and the cost of such placement, can change moment by moment. More specifically, in the context of internet advertising, the cost of placement of an ad at any given moment in time can change substantially from the cost of placement of the same ad at a just previous moment in time. Worse, the optimization of an internet advertising campaign demands consideration of “inventory” of web pages in which to place an ad (e.g., a web page viewer who is male, living in San Francisco, age 18-21, etc.). If the inventory is plentiful, then the cost of accessing that inventory would tend to go down (e.g., in a marketplace). Conversely, if inventory is scarce, then the cost of accessing that scarce inventory would go up. Still worse, even if the cost of accessing that scarce inventory were priced at a premium, it might still be optimal to pay the premium in order to optimize the overall goals of the campaign.

In order to optimize the placement of ads, the internet advertising network needs to consider instantaneous conditions surrounding the campaign, including instantaneous inventory and instantaneous pricing. Yet, the traditional “buying experience” between an advertiser and an ad agency calls for only periodic (e.g., quarterly, monthly, weekly) communication in which the advertiser and agency can assess and make changes in the ad campaign in an attempt to optimize the results. What is needed is a “simpler buying experience”. More specifically, what is needed is an automated fine-grained optimization of an internet advertising campaign such that the optimization considers both instantaneous inventory and instantaneous pricing.

Other features and advantages will be apparent from the accompanying drawings, and from the detailed description that follows below.

### SUMMARY

A method, system, and computer program product for using advertising campaign allocation optimization results to calculate bids. The method commences by receiving a candidate impression opportunity corresponding to an advertising campaign that has both branding objectives and performance-based objectives. Contracts that can be satisfied by serving the candidate impression opportunity use advertising campaign allocation optimization results to determine a set of matching contracts. Given the matching contracts, the method continues to calculate bids for those matching contracts, then selects a target contract from among the matching contracts. The method then bids on the candidate impression opportunity using the calculated bid of the selected target contract. The method optimizes for overall campaign performance even when the campaign includes both branding campaign objectives and performance-based campaign objectives. The method tallies fulfillment when the calculated bid is the winning bid, and the campaign allocation optimization results are re-calculated in readiness for another placement.

### BRIEF DESCRIPTION OF THE DRAWINGS

The novel features are set forth in the appended claims. However, for purpose of explanation, several embodiments are set forth in the following figures.

FIG. 1 depicts a network for using advertising campaign allocation optimization results to calculate bids, according to some embodiments.

FIG. 2 shows a data flow for using advertising campaign allocation optimization results to calculate bids, according to some embodiments.

FIG. 3 depicts a process for using advertising campaign allocation optimization results to calculate bids, according to some embodiments.

FIG. 4 depicts a data flow for using advertising campaign allocation optimization results to calculate bids, according to some embodiments.

FIG. 5 depicts an interview form for use in a branding advertising campaign, according to some embodiments.

FIG. 6 depicts an interview form for use in a performance-driven advertising campaign, according to some embodiments.

FIG. 7 is a flow chart for using advertising campaign allocation optimization results to calculate bids, according to some embodiments.

FIG. 8 depicts system for using advertising campaign allocation optimization results to calculate bids, according to some embodiments.

FIG. 9 is a schematic diagram illustrating an example embodiment of an advertising network, according to some embodiments.

FIG. 10 is a schematic diagram illustrating an example embodiment of a client device, according to some embodiments.

FIG. 11 is a block diagram of a computer system, for implementing embodiments.

Like reference characters refer to corresponding parts throughout the drawings.

### DETAILED DESCRIPTION

Reference will now be made to various embodiments, some examples of which are illustrated in the accompanying drawings.

### Overview

The disclosure herein describes embodiments of a contract fulfillment system for non-guaranteed display (NGD) advertising. An NGD contract is an agreement between an advertiser and an originator (e.g., an internet property operator, an agent, a fulfillment system operator, etc.) for placement of ads into impressions (selected from an inventory of impressions) that are purchased through external ad exchanges. This allows the originator of an NGD contract to sell NGD contracts based on a supply (e.g., expectation of a future supply of impressions) that is not owned and/or operated by the originator. In addition, the herein-described contract fulfillment system allows for performance-based contracts to be sold with a confidence factor similar to “guaranteed delivery contracts”, and in a mix with “brand contracts” (e.g., guaranteed contracts for display advertising).

The herein-described techniques for fulfilling NGD contracts includes a contract fulfillment system in which booked contracts are fulfilled through inventory purchased via an advertising exchange (e.g., an auction server, a spot market exchange, etc.). The herein-described techniques include algorithms and calculations that prescribe how to bid (e.g., when to bid, how much to bid, etc.) on an exchange in order to maximize the profit of the originator of the contracts while satisfying the terms of the contracts, which terms of the contract can include achievement of quantitative performance metrics.

For purposes of the discussions herein, NGD contracts can be described in the following form:

Deliver X number of actions for $Y, under the terms of a campaign:
starting at time S,
ending at time E,
with constraints C.

In operation, (further described below), the fulfillment system purchases inventory through an exchange (e.g., on the spot market) in order to satisfy the booked contracts. In this way, NGD contracts allow specialists (e.g., an agent, a representative of the advertising network operator) to delegate the strategic responsibility of bidding on an ad exchange. The system facilitates fulfillment of all considered advertising contracts. Such contracts may originate in advertising campaigns deriving from various sources, and may comprise myriad campaign objectives. The herein-described system will select appropriate fulfillment policies depending on the specifics of the contract or contracts under consideration.

In one aspect, following the techniques described herein shift the responsibility of various aspects of campaign optimization from human campaign specialists (e.g., agents, sales people) to the automated contract fulfillment system. Some of these aspects include fine-grained targeting, bid generation, A/B strategy testing, selection of creative (e.g., selection of advertisements), and budget optimization. In some cases, human campaign specialists merely submit high-level objectives and constraints (e.g., as received from an advertiser), and the fulfillment system prosecutes the campaign on the basis of the given objectives and constraints.

### EXAMPLE

Consider the following campaign specification from an advertiser “Alice” in which campaign Alice suggests, “I want 1,000 clicks and I am willing to spend $1,000 over the course of one month.”

An advertiser “Alice” might discuss her campaign objectives and constraints with her agent. The agent would then generate a set of messages or advertisements (e.g., including creative material) for her campaign. Then the agency books contracts with one or more ad networks. In exemplary cases, and as further described below, an ad network has a relationship with one or more exchanges (e.g., Right Media Exchange, RMX).

A specialist “Bob” might be responsible for booking the contract, and Bob would need to construct data records to describe the parameters (e.g., objectives and constraints) under which Alice's contract can be fulfilled. It remains a question though, “What bidding policy will optimize the results of the campaign?”

Continuing this example, assume that Bob has access to forecasting and prediction tools, so Bob can use such tools to design campaigns that seek to achieve Alice's campaign objectives (while observing Alice's campaign constraints). For example, Bob might specify a cost per impression (CPM) campaign model, and/or Bob might specify a cost per click (CPC) campaign model. It is possible that Bob might want to specify a component of Alice's campaign using a cost per click (CPC) campaign model, however, in the event that Alice's new marketing campaign relies on click-through rates that are unknown, publishers may refuse to accept CPC pricing from Alice.

Continuing this example, and in a slightly more sophisticated model, Bob might specify (e.g., on Alice's behalf) that he will bid $0.0001 for any impression where Alice's expected value per impression (eCPI) exceeds the bid amount. In this case, the eCPI is the product of the value per click and the clickthrough rate (X): $1.00λ. Following this model, if Bob bids, he bids a static amount (e.g., $0.10 CPM), however he might choose to bid only on high-value impressions. This might incur a high degree of management overhead. For instance, males in California between 20-30 years of age may have a click-through rate (CTR) of 0.01%, whereas females in New York may have a CTR of 0.02%. Thus, Bob may have to generate two campaigns: one for males in California between 20-30 years of age and one for females in New York. In the former campaign, he elects to bid $0.10 CPM (or less), whereas in the latter campaign, he chooses to bid $0.20 CPM (or less). The foregoing is merely a simplified example. In a more general case, Bob might have to specify a large number of campaigns in order to optimize Alice's campaign objectives. Further, he would need to modify his bids as the bidding landscape changes over time. This might incur a high degree of management overhead. Still more, Bob's campaigns have only considered how to set bids to improve Alice's results. Yet Bob also has to consider the budget constraint of $1,000 for the month. Although many technique exist to stay within a stated spending limit (e.g., stop spending when the limit is reached), Bob really needs to consider the remaining budget when selecting his bids. For instance, Bob might be able to predict the availability of cheaper placements that might occur later in the duration of the campaign.

### Action-Rate Prediction and Supply Forecasting

Modern ad networks have access to prediction services for click-through rates and conversion rates based on user, publisher, and creative information. The NGD contract fulfillment system will require the same information when optimizing its bids. Such services are used in order to optimize the campaign spend. The systems described herein serve to produce campaign recommendations. Further, the disclosed systems can recommend targeting attribute changes in order for NGD campaigns to meet advertiser optimization goals. Such recommendations are based (at least in part) on advanced data analysis and data mining over multiple data sources.

Reference will now be made in further detail to various embodiments, some examples of which are illustrated in the accompanying drawings. It will be understood that the described embodiments are not intended to limit the scope of the claims. On the contrary, the embodiments are intended to cover alternatives, modifications and equivalents, which may be included within the scope of the appended claims. Furthermore, in the following detailed descriptions, numerous specific details are set forth in order to provide a thorough understanding of the exemplary embodiments. However, one of ordinary skill in the art can recognize that the present advances may be practiced without these specific details. In other instances, well known methods, procedures, components, and circuits have not been described in detail so as avoid unnecessarily obscuring aspects of the described embodiments.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and”, “or”, or “and/or” as used herein may include a variety of meanings that may depend at least in part upon the context in which such terms are used. Typically, “or” if used to associate a list; for example, a list such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, depending at least in part on context.

Some portions of the detailed descriptions which follow are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc. as may be used herein is generally conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions using terms such as “processing” or “computing” or “communicating” or “instantiating” or “registering” or “selecting”, or “displaying” or the like, refer to the action and processes of a computer system or similar electronic computing device that manipulates and transforms data represented as physical (electronic) quantities within the computer system's registers and memories into other data similarly represented as physical quantities within the computer system memories or registers or other such information storage, transmission or display devices.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

### Section I: General Terms

Some of the terms used in this description are defined below (in alphabetical order) for easy reference. These terms are not rigidly restricted to these definitions. A term may be further defined by the term's use in other sections of this description.

“Ad” (e.g., ad, item and/or message) means a paid announcement, as of goods or services for sale, preferably on a network such as the internet. An ad may also be referred to as an item and/or a message.

“Ad call” means a message sent by a computer to an ad server for requesting an ad to be displayed.

“Ad click-through rate” (e.g., click-through rate) means a measurement of ad clicks per a period of time.

“Ad code” means the HTML or other markup language description that describes an advertisement or message in such a manner as can be parsed by a browser. Ad code may include references to other ad code. Ad code may mean any subset, or portion or segment of ad code that describes an advertisement or message in such a manner as can be parsed by a browser.

An “Ad server” comprises a server that stores online advertisements for presentation to users. “Ad serving” refers to methods used to place online advertisements on websites, in applications, or other places where users are more likely to see them, such as during an online session or during computing platform use, for example. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

“Advertiser” (e.g., messenger and/or messaging customer, etc.) means an entity that is in the business of marketing a product and/or a service to users. An advertiser may include, without limitation, a seller and/or a third-party agent for the seller. An advertiser may also be referred to as a messenger and/or a messaging customer. Advertising may also be referred to as messaging.

“Advertising” means marketing a product and/or service to one or more potential consumers by using an ad. One example of advertising is publishing a sponsored search ad on a website.

“Ad targeting” or “targeting” refers to web portals like Yahoo!, where advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s). Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

“Application server” is a server that is configured for running one or more devices loaded on the application server. For example, an application server may run a device configured for deducing shadow profiles.

“Click” (e.g., ad click) means a selection of an ad impression by using a selection device such as, for example, a computer mouse or a touch-sensitive display.

“Client” means the client part of a client-server architecture. A client is typically a user device and/or an application that runs on a user device. A client typically relies on a server to perform some operations. For example, an email client is an application that enables a user to send and receive email via an email server. In this example, the computer running such an email client may also be referred to as a client.

A “Computing device” means a computing device that may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

A “Content server” is a server that may include a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

Examples of devices that may operate as a content server include desktop computers, multiprocessor systems, microprocessor-type or programmable consumer electronics, etc.

“Conversion” (e.g., ad conversion) means a purchase of a product/service that happens as a result of a user responding to an ad and/or a coupon.

A “Content delivery network” or “Content distribution network” (CDN) refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

“Coupon” (e.g., coupon ad) means a portion of a certificate, ticket, label, ad or the like—set off from the main body by dotted lines or the like to emphasize its separability—entitling the holder to something, such as a gift or discount, or for use as an order blank or a contest entry form, etc. A coupon is designed in a convenient format for a user to “take” the coupon to a seller to receive an advertised benefit.

“Database” (e.g., database system, etc.) means a collection of data organized in such a way that a computer program may quickly select desired pieces of the data. A database is an electronic filing system. In some instances, the term “database” is used as shorthand for a “database management system”. A database may be implemented as any type of data storage structure capable of providing for the retrieval and storage of a variety of data types. For instance, a database may comprise one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

“Device” means hardware, software or a combination thereof. A device may sometimes be referred to as an apparatus. Examples of a device include, without limitation, a software application such as Microsoft Word™ or a database; or hardware such as a laptop computer, a server, a display; or a computer mouse and/or a hard disk.

“Impression” (e.g., ad impression) means a delivery of an ad to a user device for viewing by a user.

The “Internet” refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

“Item” means an ad, which is defined above.

“Marketplace” means a world of commercial activity where products and/or services are browsed, bought and/or sold, etc. A marketplace may be located over a network, such as the internet. A marketplace may also be located in a physical environment, such as a shopping mall.

“Message” means an ad, which is defined above.

“Messaging” means advertising, which is defined above.

“Messenger” means an advertiser, which is defined above.

“Monetization techniques” or “Monetization models” refers to techniques used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example. A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

“Network” means a connection, between any two or more computers, that permits the transmission of data. A network may be any combination of networks including, without limitation, the internet, a local area network, a wide area network, a wireless network, and/or a cellular network.

A “Network” means a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

A “peer-to-peer network” or “P2P network” may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

“Publisher” means an entity that publishes, on a network, a web page having content and/or ads, etc. and/or publishes, on a network, a downloadable application and/or other digital context having digital content and/or digital ads, etc.

“Server” means a software application that provides services to other computer programs (and their users) on the same computer or on another computer or computers. A server may also refer to the physical computer that has been set aside to run a specific server application. For example, when the software Apache HTTP Server is used as the web server for a company's website, the computer running Apache may also be called the web server. Server applications may be divided among server computers over an extreme range, depending upon the workload. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

“Social network” or “social networking website” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be generated according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, personal computers, televisions, SMS/MMS, email, instant messenger clients, forums, social networking sites (such as Facebook, Twitter, or Google+), or the like.

“Software” means a computer program that is written in a programming language that may be used by one of ordinary skill in the art. The programming language chosen should be compatible with the computer on which the software application is to be executed and, in particular, with the operating system of that computer. Examples of suitable programming languages include, without limitation, Object Pascal, C, C++ and/or Java. Further, the functions of some embodiments, when described as a series of steps for a method, could be implemented as a series of software instructions for being operated by a processor such that the embodiments could be implemented as software, hardware, or a combination thereof. Computer-readable media are discussed in more detail in a separate section below.

“System” means a device or multiple coupled devices. A device is defined above.

“User” (e.g., consumer, etc.) means an operator of a user device. A user is typically a person who seeks to acquire a product and/or service. For example, a user may be a woman who is browsing Yahoo!™ Shopping for a new cell phone to replace her current cell phone. The term “user” may also refer to a user device, depending on the context.

“User device” (e.g., computer, user computer, client and/or server, etc.) means a single computer or a network of interacting computers. A user device is a computer that a user may use to communicate with other devices over a network, such as the internet. A user device is a combination of a hardware system, a software operating system, and perhaps one or more software application programs. Examples of a user device include, without limitation, a laptop computer, a palmtop computer, a smart phone, a cell phone, a mobile phone, an IBM-type personal computer (PC) having an operating system such as Microsoft Windows™, an Apple™ computer having an operating system such as MAC-OS, hardware having a JAVA-OS operating system, and/or a Sun Microsystems™ workstation having a UNIX operating system.

“Web browser” means a software program that may display text or graphics or both, from web pages on websites. Examples of a web browser include, without limitation, Mozilla Firefox™ and Microsoft Internet Explorer™.

“Web page” means documents written in a mark-up language including, without limitation, HTML (hypertext mark-up language), VRML (virtual reality modeling language), dynamic HTML, XML (extensible mark-up language), and/or other related computer languages. A web page may also refer to a collection of such documents reachable through one specific internet address and/or through one specific website. A web page may also refer to any document obtainable through a particular URL (uniform resource locator).

“Web portal” (e.g., public portal) means a website or service that offers a broad array of resources and services such as, for example, email, forums, search engines, and online shopping malls. The first web portals were online services, such as AOL, that provided access to the web. However, now, most of the traditional search engines (e.g., Yahoo!™) have transformed themselves into web portals to attract and keep a larger audience.

“Web server” is a server configured for serving at least one web page to a web browser. An example of a web server is a Yahoo!™ web server. A server is defined above.

### Section II: Descriptions of the Figures

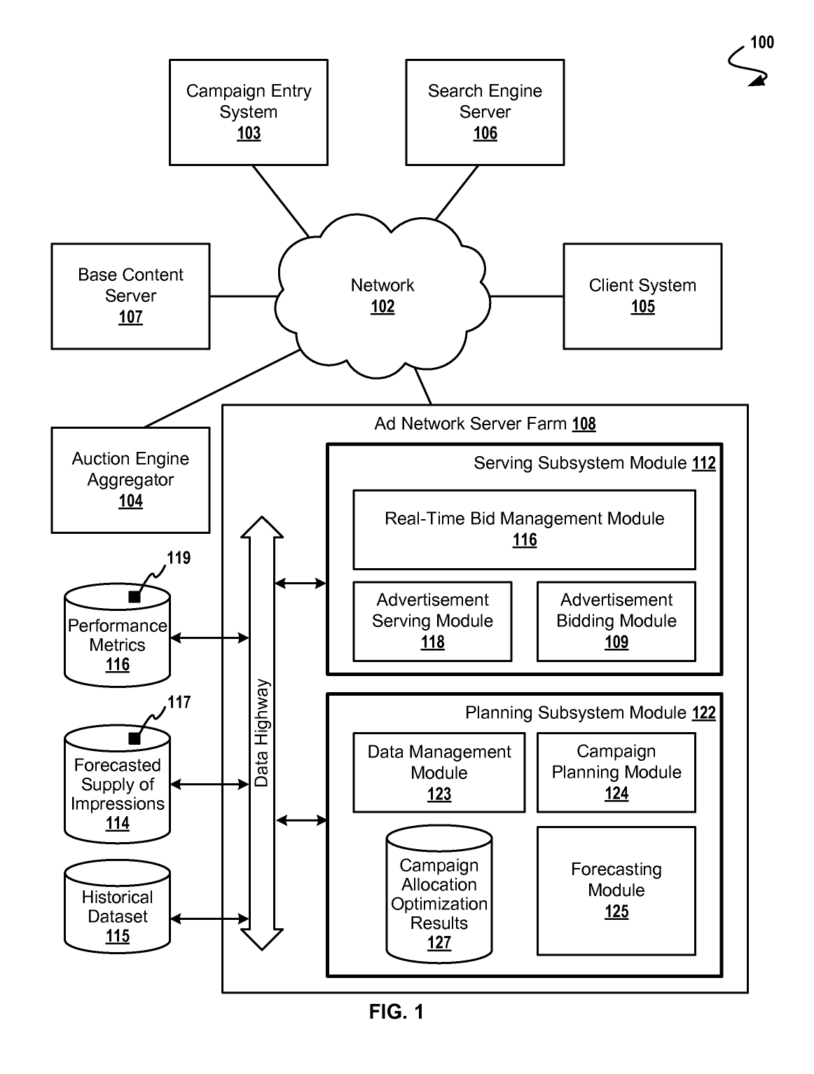

FIG. 1 depicts an advertising network for using advertising campaign allocation optimization results to calculate bids. As an option, the present advertising network 100 may be implemented in the context of the architecture and functionality of the embodiments described herein. Of course, however, the advertising network 100 or any operation therein may be carried out in any desired environment.

FIG. 1 shows an ad network environment including a real-time bid management module 116 in which some embodiments may operate. In the context of internet advertising, placement of advertisements within web pages has become common. An internet advertiser or agent may select a particular property (e.g., Yahoo.com, www.disney.com, etc.), and the internet property operator may host content in a base content server 107. An agent may use a campaign entry system 103 to describe a campaign, and may use additional content servers to generate an advertisement on-demand such that whenever any internet user, via a client system 105 (e.g., a client device as further described herein), renders a web page from the selected property, the advertisement (e.g., a creative) is composited on the web page by one or more servers (e.g., base content server 107, search engine server 106), and/or using an additional server (e.g., within ad network server farm 108). The base content and advertisement is packaged for delivery to a client system 105 over a network 102. Given this generalized delivery model, and using techniques disclosed herein, internet advertising might be practiced, and ad traffic can occur between a client system 105 and any other server over a network 102.

Again referring to FIG. 1, an internet property (e.g., a publisher hosting of the publisher's base content on a base content server 107) might be able to display an advertisement (e.g., aided by an advertisement serving module 118), and then measure the characteristics of visitors (which visitors may have any arbitrary interest, demographic, target predicates, or other attributes) possibly using an ad network server farm 108 in conjunction with a historical dataset 115 as pertains to observed users. Thus, an internet user's interests, demographics, target predicates, and/or other attributes might be known in quite some detail, and a forecasting module 125 might forecast a future supply of impressions that accord to the demographics, target predicates, and/or other attributes. More specifically, a user's clicks (e.g., the likelihood of a click on an ad, or the likelihood of a user action based on an ad) or other responses to an internet advertisement might also be known in quite some detail, not only for a particular user, but also for a group of users corresponding to a particular subset of the available data, and a campaign forecast generation module might use such a particular subset of the available data for forecasting a future supply of impressions where the forecast of a future supply of impressions is organized into groups, the members of the groups being impressions satisfying a particular target predicate. For example, a future supply of impressions may be organized into groups corresponding to a demographic of interest to an advertiser (e.g., “(GENDER=male && AGE_RANGE={20-30})”. By definition, a forecasted supply of impressions 114 may comprise one or more instances of a forecasted impression 117.

A campaign planning module 124 might use any such available data for operations for campaign planning and for campaign parameter tuning, and such data can be managed by a data management module 123. Furthermore, any one or more allocation regimes might be applied to optimize one or another metric for multiple contracts that can satisfy demands of an ad campaign. In some embodiments, a campaign allocation optimization module serves to apply an allocation and optimization regime.

A performance-driven advertising campaign parameter may include performance metrics 113. By definition, performance metrics 113 may comprise one or more instances of a performance metric 119. In some campaigns that fulfill placements by bidding, the bids can be provided (e.g., from an advertisement bidding module 109) to a real-time bid management module 116, and bids are submitted in real-time to an auction engine aggregator 104. When a bid wins at auction for the opportunity to present an advertisement in an impression, then an advertisement serving module 118 composites the ad in real-time. Also, when a bid wins (or loses) at auction for the opportunity to present an advertisement in an impression, then a data management module 123 tallies the result.

Certain embodiments in certain environments comprise cooperative combinations of online subsystems (e.g., serving subsystem module 112) and offline subsystems (e.g., planning subsystem module 122). The aforementioned partitioning into online subsystems and offline subsystems is merely an illustrative partitioning; other partitioning boundaries are reasonable and envisioned.

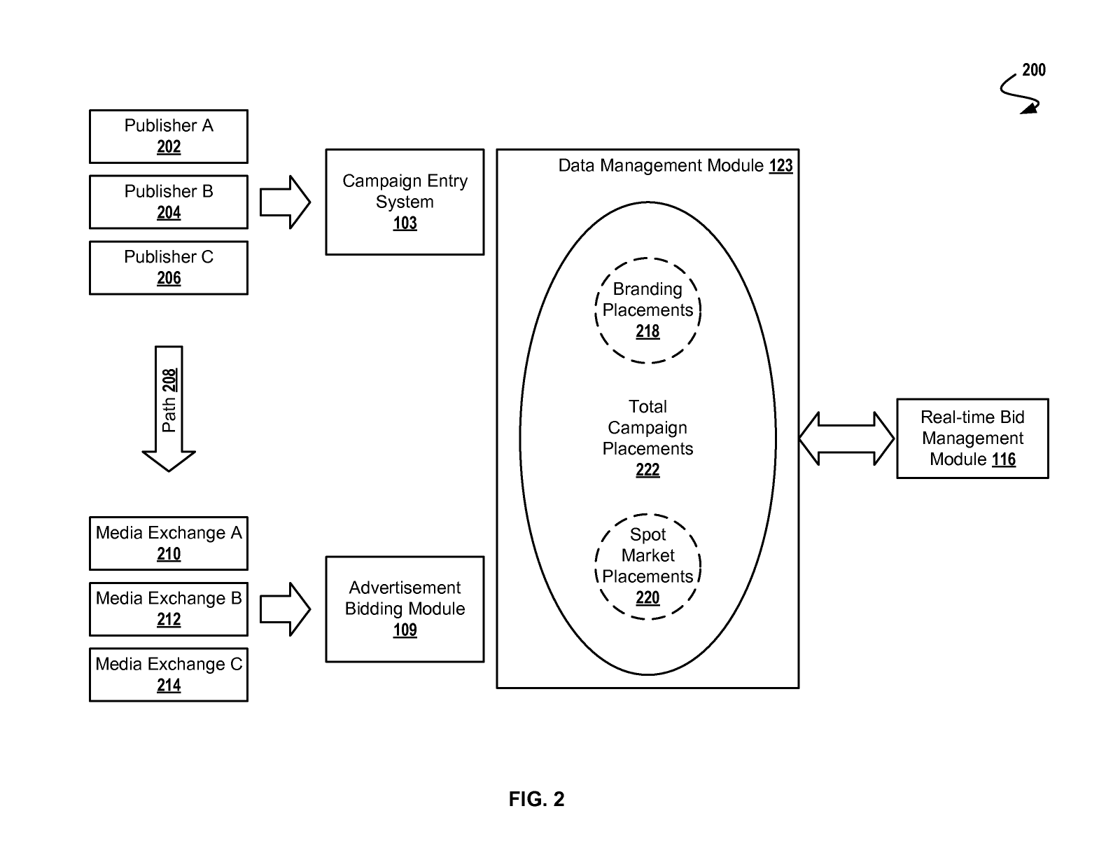

FIG. 2 shows a data flow for using advertising campaign allocation optimization results to calculate bids. As an option, the present data flow 200 may be implemented in the context of the architecture and functionality of the embodiments described herein. Of course, however, the data flow 200 or any operation therein may be carried out in any desired environment.

An advertiser's campaign characteristics can be entered by an agent, possibly using a campaign entry system, and any number of publishers (e.g., Publisher A 202, Publisher B 204, Publisher C 206, etc.) can provide an accounting of a future inventory offering that can be known in advance of campaign entry. Also, a publisher or any combination of publishers can provide an accounting of a future inventory offering to any one or more media exchanges (e.g., Media Exchange A 210, Media Exchange B 212, Media Exchange C 214, etc.). The communication path 208 can be an automated path, or it can be a human-aided path.

As shown, the operations for serving an ad into an impression can be accomplished by effecting a branding placement 218, or by some form of bidding, as may be facilitated by an advertisement bidding module 109 in combination with a real-time bid management module 116.

Once a placement has been effected, the data management module 123 can tally the placement into the total campaign placements 222, tallying the placement into either the branding placements 218 or into spot market placements 220. The selection of an impression for placement, and the bidding to secure the impression for the placement, can be performed by a subsystem such as the serving subsystem module 112 (see FIG. 1).

### Declarative Contract Fulfillment

Given the architecture of FIG. 2, and given availability of a forecast of impressions available through the one or more media exchanges, it is possible for a specialist to specify campaign terms declaratively. For example, campaign specialists may manage contracts through a media exchange. In this regime, a specialist may construct an insertion order that contains multiple line items, each listing multiple campaigns where each campaign defines (explicitly or implicitly) a separate objective. This situation presents a multi-objective optimization problem to the campaign optimizer (e.g., the serving subsystem module 112).

In a multi-objective optimization problem, the campaign manager (e.g., serving subsystem module 112) will implement a method, either implicit or explicit, that serves to trade-off one objective for another. In performance-driven campaigns, it is often possible to coalesce multiple objectives under a single common objective, such as “return on investment”, and each objective can contribute or detract from the return on investment objective metric. Given the mixed objectives that are found in a campaign that combines brand objectives with performance-driven objectives in the combined campaign, the campaign prosecution optimization techniques make certain assumptions as to the value (e.g., ROI value) of the branding placements. However, it is not guaranteed that certain assumptions as to the value (e.g., ROI value) of the branding placements are identical to the value ascribed by the advertiser when the advertiser defined the contract. What is needed is a bidding policy that helps advertiser to maximize ROI, yet does not require undue overhead by the advertisers or agents in order to tune the campaign parameters to achieve campaign objectives—even in the face of a changing market.

Shown and described below, is a contract fulfillment system serves to define bidding policies that will handle typical advertiser contracts, even when such advertiser contracts combine branding as well as performance-driven objectives. That is, systems using the aforementioned aspects of an ad network can select the appropriate bidding policies based on contract specifications. Moreover, such systems may test prospectively various policies that might yield the best outcomes over the duration of the contract period.

### Simplified Budget Management

In accordance with the disclosed techniques, each contract has a single budget specifying how that budget is to be spent over time (e.g., over the duration of the campaign) and with respect to supply (e.g., constraints on maximum bids). Budget splitting is handled by the optimization algorithm (e.g., in real time) rather than having budget splitting being imposed as an a priori constraint.

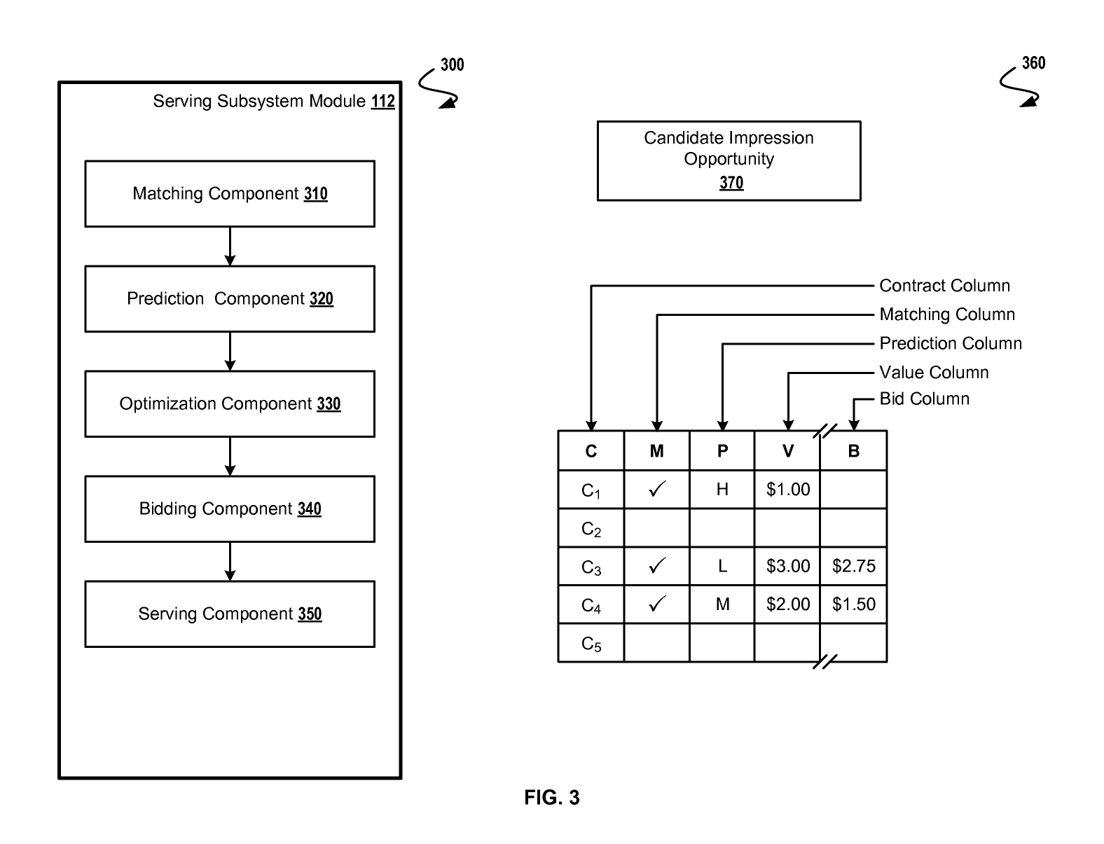

FIG. 3 depicts a process for using advertising campaign allocation optimization results to calculate bids. As an option, the present process 300 may be implemented in the context of the architecture and functionality of the embodiments described herein. Of course, however, the process 300 or any operation therein may be carried out in any desired environment.

As previously described, a contract has an associated set of objectives comprising performance-oriented objectives and branding objectives. In combination, this associated set of objectives is used to manage the timing and amount of bids. In exemplary embodiments the management of the timing and amount of bids entails aspects of matching, prediction, optimization, bidding, and serving in a flow, which flow is presently discussed.

FIG. 3 shows one possible processing flow. The flow can be amalgamated into an online component (e.g., a serving subsystem module 112), which in turn comprises various components, each of which are discussed in turn. The matching component 310 determines a list of matching contracts for a given impression. Referring to the right side of FIG. 3, such a list can be formed via the construction of an array, or in a table such as tabular format 360. In particular, given a candidate impression opportunity 370, the tabular format can be populated with a set of matching contracts (e.g., see the column “contract column”). In some cases, matching can be accomplished based on an opportunity-attribute format, and such a match can be indicated in the table (e.g., see the “matching column”). Given a candidate impression opportunity 370 and at least a partial match, a prediction component 320 serves to annotate each matching contract with the requisite predictions for each request. For example, the prediction component might codify the likelihood that additional inventory would be available in a future timeframe (e.g., a future timeframe during the remaining duration of the campaign, and/or it can codify predicted action rates. The values can be normalized in any convenient way, and/or merely noted in some relative terms (e.g., see “H”, “L”, and “M”, in the “prediction column”). Processing continues to an optimization component 330. The optimization component calculates or obtains a set of contracts to be fulfilled, and the set of contracts to be fulfilled are drawn from the results of an allocation optimization performed on behalf of the contract maker, or on behalf of the agent, or on behalf of the advertising network operator, etc. Thus selecting from among the provided (pre-optimized) contracts accomplishes a desired feature of using advertising campaign allocation optimization results to determine a set of matching contracts that satisfy the candidate impression. Further, the optimization component constructs the value for the opportunity from the list of matching ads, together with their respective predicted action rates. Strictly as an example, the contract C₁ (e.g., for males in California) has a campaign-assigned value of $1.00 per impression. And, the contract C₃ (e.g., for males in California between ages 21-30) has a campaign-assigned value of $3.00 per impression. Processing further progresses to a bidding component 340. The bidding component uses the value from the optimization component to calculate an actual bid, and supplies the bid value to the real-time bid management module 116. Of course, the bid constructed for bidding on the candidate impression opportunity might be greater than (or less than) the campaign-assigned value. For example, a campaign might specify a campaign-assigned value for a particular demographic, but that particular demographic is not only high value to the campaign, but is also forecasted to be in short supply for the remainder of the campaign. In this situation, the bid price might be increased to a bid price higher than (for example) the known second price spot market quote.

To determine the optimal bid, then for each matching contract, the optimization component 330 computes a value-per-placement for the candidate impression, selects the contract (and corresponding bid) that maximizes that value, and a bidding component 340 submits the bid to a media exchange (e.g., through an auction engine aggregator 104). Assuming the bid is the winning bid, then processing moves to a serving component 350, and the serving component selects an advertisement to be composited into the impression and displayed for the user. If the bidding activity succeeds to wins the right to serve an advertisement in the candidate impression, then an ad is deemed as having been served, and the nature of that event is tallied in the data management module 123.

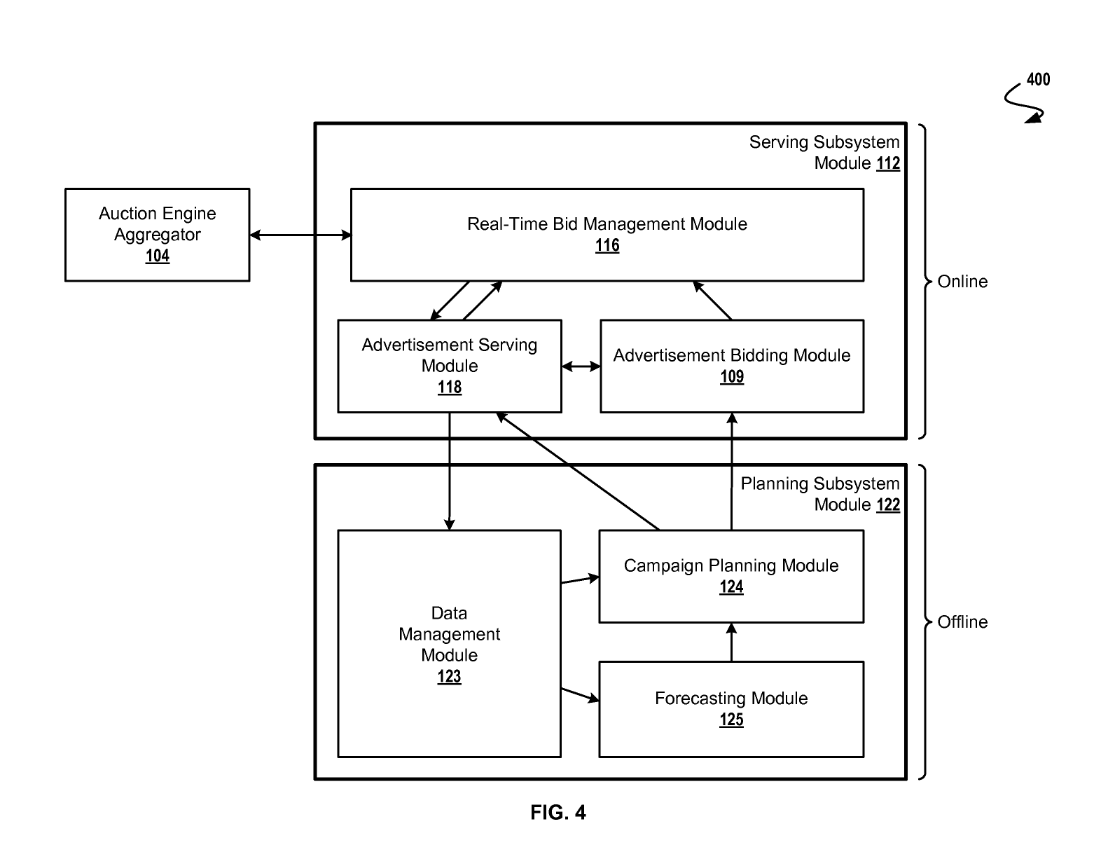

FIG. 4 depicts a data flow for using advertising campaign allocation optimization results to calculate bids. As an option, the present data flow 400 may be implemented in the context of the architecture and functionality of the embodiments described herein. Of course, however, the data flow 400 or any operation therein may be carried out in any desired environment.

The foregoing processing of FIG. 3 can be performed in any environment. And, some such environments comprise an online subsystem (e.g., serving subsystem module 112) and an offline subsystem (e.g., planning subsystem module 122), as shown. The processing of FIG. 3 can be performed, for example, where a serving subsystem module 112 and a planning subsystem module 122 communicate cooperatively to process campaign allocation optimization results, and to calculate bids. More specifically, given an opportunity (e.g., candidate impression opportunity 370), an advertisement bidding module 109 serves to identify each matching contract with the requisite predictions for each request. For example, the advertisement bidding module might codify the likelihood that additional inventory would be available in a future timeframe (e.g., a future timeframe during the remaining duration of the campaign). In another example, the advertisement bidding module might codify predicted action rates (e.g., click-through rates). Processing then further progresses to a real-time bid management module 116. The real-time bid management module calculates the actual bid, and supplies the bid value to the auction engine aggregator 104. Assuming the bid is the winning bid, then processing moves to an advertisement serving module 118, and the advertising serving module selects an advertisement to be composited into the impression and displayed for the user. If the bidding activity succeeds to win the right to serve an advertisement in the candidate impression then an ad is deemed as having been served, and the nature of that event is tallied in the data management module 123.

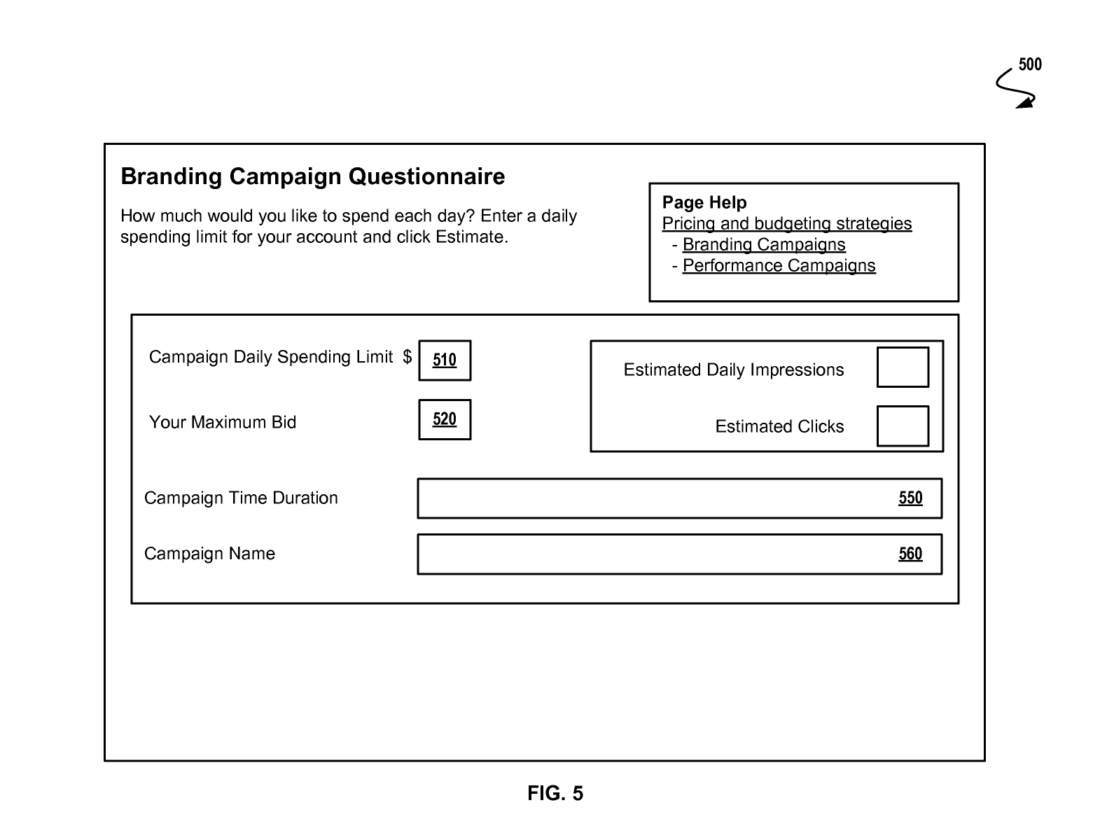

FIG. 5 an interview form for a branding advertising campaign for use in calculating bids. As an option, the present form 500 may be implemented in the context of the architecture and functionality of the embodiments described herein. Of course, however, the form 500 or any operation therein may be carried out in any desired environment.

FIG. 5 is a form 500 for collecting information regarding a branding campaign, according to one embodiment. As shown, the form for collecting information regarding a branding campaign seeks to guide an advertiser through a series of questions for defining campaign objectives and constraints. Strictly as examples, the “Campaign Daily Spending Limit” question and value 510 serves to collect information about an advertiser's spending limit. The “Your Maximum Bid” question and value 520 serves to collect information about the advertiser's maximum bid constraint. The “Campaign Time Duration” question and value 550 serves to collect information about a campaign time duration. The “Campaign Name” question and value 560 serves to collect information about the advertiser's individual campaign name. Exemplary embodiments comprise campaigns having both branding objectives (e.g., total impressions fulfilled) as well as performance objectives (e.g., maximize ROI). Or, a single amalgamated campaign can be composed from multiple individual campaigns. As such a form 500 serves to capture campaign objectives and constraints.

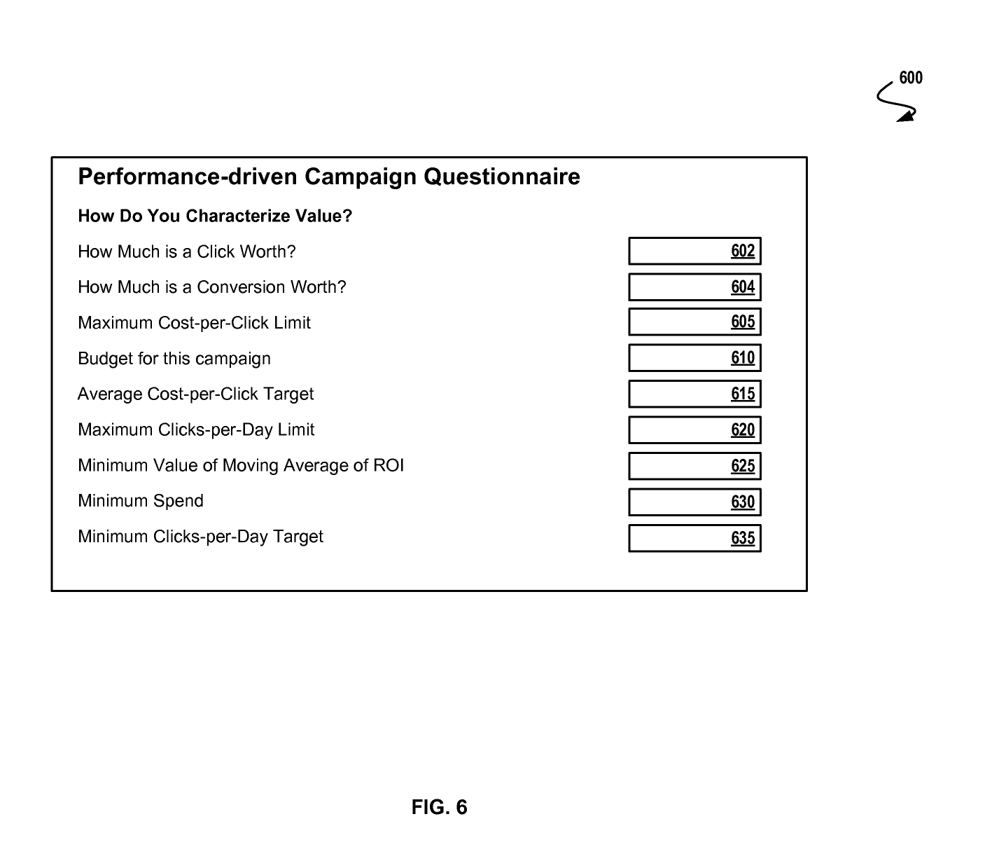

FIG. 6 depicts a form for use in a performance-driven advertising campaign. As an option, the present form 600 may be implemented in the context of the architecture and functionality of the embodiments described herein. Of course, however, the form 600 or any operation therein may be carried out in any desired environment.

FIG. 6 is a form for collecting information regarding objectives and constraints within a performance-driven advertising campaign, according to one embodiment. As shown, the form for collecting information regarding objectives and constraints includes an area for defining how much a click is worth 602, an area for defining how much a conversion is worth 604, an area for defining a maximum cost-per-click limit 605, an area for defining total budget for this campaign 610, an area for defining a target average cost-per-click 615, an area for defining a maximum clicks-per-day limit 620, an area for defining a minimum value of a moving average of ROI 625, an area for defining a minimum spend 630, and an area for defining a minimum clicks-per-day target 635.

In various embodiments, advertising is placed by a variety of different types of advertisers (e.g., large advertisers, small advertisers, advertisers seeking brand advertising, advertisers seeking conversions, etc.), where each type of advertiser is holding interests in a variety of campaign objectives and constraints. Therefore, embodiments allow advertisers to express a diverse set of objectives/constraints (e.g., using the form for collecting information regarding objectives and constraints). At the same time, the interface (e.g., form, screen device, etc.) of such an embodiment might be sufficiently rich so as to assist the advertiser toward expressing only the most economically sensible constraints. Moreover, the interface (e.g., form, screen device, etc.) of such an embodiment might be sufficiently rich so as to show the estimated impact of various settings and/or changes in the campaign objectives and constraints.

Of course, there exists a wide range of possible campaign objectives and constraints. Strictly as an example, an objective function for an advertiser's advertising campaign might be a net utility value, expressed as the sum of the values of clicks received during some time period minus the cost of operating the campaign over that same time period. Another objective function for an advertiser's advertising campaign might comprise a return on investment value (ROI, also known as the return on advertising spend—ROAS). ROI is equal to the total value received divided by the cost. For example, the combination of this objective function with a minimum spend constraint might be useful for advertisers who only know their advertising budget as well as the relative (and not the absolute) value of a click from each keyword.

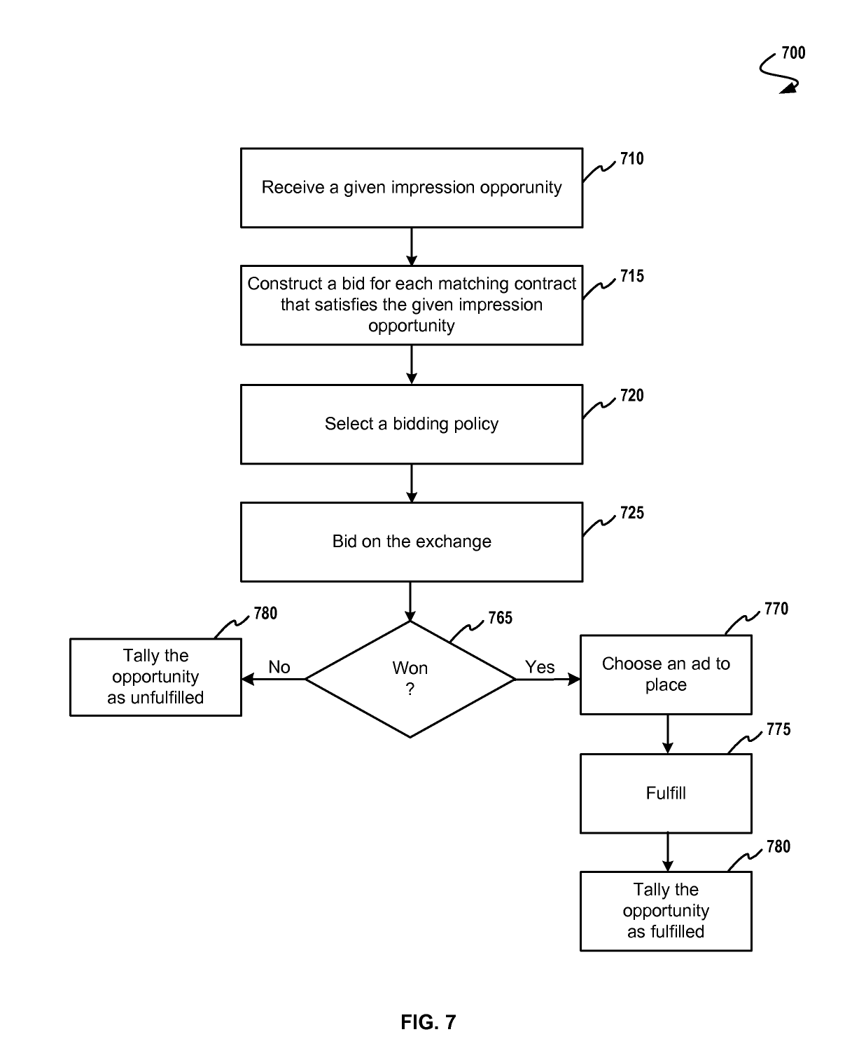

FIG. 7 is a flow chart for using advertising campaign allocation optimization results to calculate bids. As an option, the present flow chart 700 may be implemented in the context of the architecture and functionality of the embodiments described herein. Of course, however, the flow chart 700 or any operation therein may be carried out in any desired environment.

As shown, the flow commences upon receipt of a given impression opportunity (see operation 710) and for the given impression opportunity the processing constructs a bid for each matching contract that satisfies the given impression (see operation 715). As earlier indicated an advertiser can mix aspects of a branding campaign with aspects of a performance-driven campaign. Accordingly, a bidding policy is selected (see operation 720). Selection of a bidding policy can include selection on the basis of any one or more of the parameter provided by the advertiser (e.g., via form 500 or via form 600), or on the basis of achievement of ROI, or any other parameter or metric. Then, given a bid and a bidding policy to (at least) select from among a plurality of possible bids, the bid is submitted on the advertising exchange (see operation 725).

If the bid is the winning bid (see decision 765), then a particular ad is selected for placement (see operation 770), the impression is composited with the selected ad, and the placement is fulfilled (see operation 775). The fulfillment is tallied (see operation 780). However, if the bid was not the winning bid (see decision 765) then the opportunity is unfulfilled, and is tallied as such.

Of course, the tally that the placement is fulfilled (or not fulfilled) can be performed in conjunction with historical data (e.g., historical dataset 115). Moreover, the availability of a tally can influence bidding. For example, if an impression opportunity can fulfill a contract with a particular demographic for which the forecasting module 125 suggests thin supply, then the various bid construction operations might bid a relatively higher bid amount. Or, the act of calculating a bid for each of the set of matching contracts can consider the likelihood of a future opportunity occurring in a future timeframe, and compares that likelihood to the campaign duration and relative amounts and importance of placements of ads to the forecasted demographic. More generally, in certain embodiments, the timing and value of a bid is responsive to the bidding landscape, a forecast, the confidence level of the forecast, and the duration of the campaign relative to the forecast.

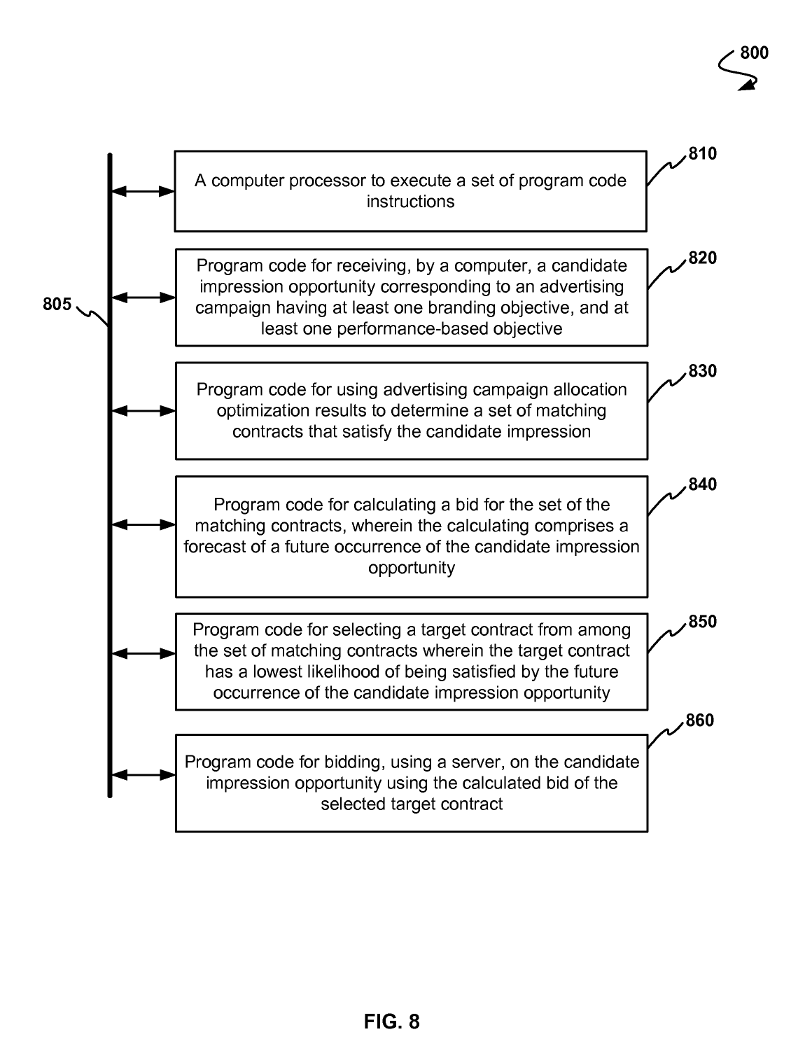

FIG. 8 depicts a block diagram of a system to perform certain functions of a computer system. As an option, the present system 800 may be implemented in the context of the architecture and functionality of the embodiments described herein. Of course, however, the system 800 or any operation therein may be carried out in any desired environment. As shown, system 800 comprises at least one processor and at least one memory, the memory serving to store program instructions corresponding to the operations of the system. As shown, an operation can be implemented in whole or in part using program instructions accessible by a module. The modules are connected to a communication path 805, and any operation can communicate with other operations over communication path 805. The modules of the system can, individually or in combination, perform method operations within system 800. Any operations performed within system 800 may be performed in any order unless as may be specified in the claims. The embodiment of FIG. 8 implements a portion of a computer system, shown as system 800, comprising a computer processor to execute a set of program code instructions (see module 810) and modules for accessing memory to hold program code instructions to perform: receiving, by a computer, a candidate impression opportunity corresponding to an advertising campaign having at least one branding objective, and at least one performance-based objective (see module 820); using advertising campaign allocation optimization results to determine a set of matching contracts that satisfy the candidate impression (see module 830); calculating a bid for the set of the matching contracts, wherein the calculating comprises a forecast of a future occurrence of the candidate impression opportunity (see module 840); selecting a target contract from among the set of matching contracts wherein the target contract has a lowest likelihood of being satisfied by the future occurrence of the candidate impression opportunity (see module 850); and bidding, using a server, on the candidate impression opportunity using the calculated bid of the selected target contract (see module 860).

### Section III: Exemplary Practice of Embodiments

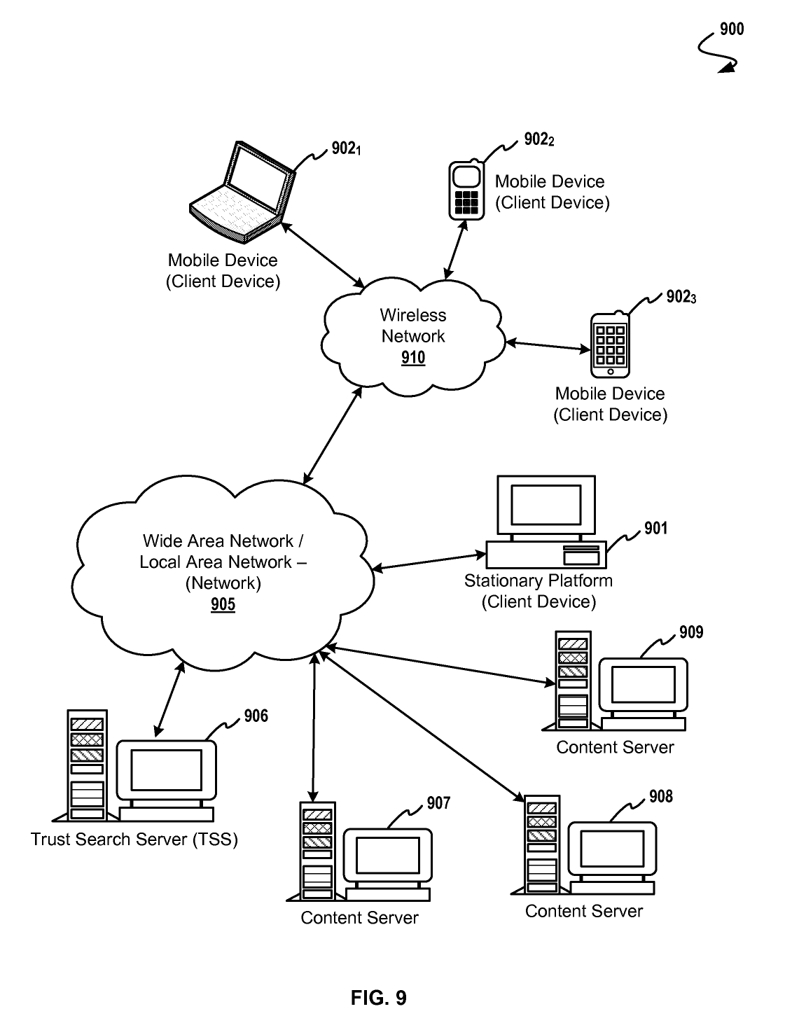

FIG. 9 is a schematic diagram 900 illustrating an example embodiment of an advertising network. Other embodiments that may vary, for example, in terms of arrangement or in terms of type of components, are also intended to be included within the claimed subject matter. As shown, FIG. 9, for example, includes a variety of networks, such as a local area local area network (LAN)/wide area network (WAN) 905 and wireless network 910, a variety of devices, such as client devices such as stationary platform 901, mobile device 902₁, mobile device 902₂, mobile device 902₃, and a variety of servers, such as local content server 907, such as remote content server 908, such as virtual content server 909 and such as search server 906.

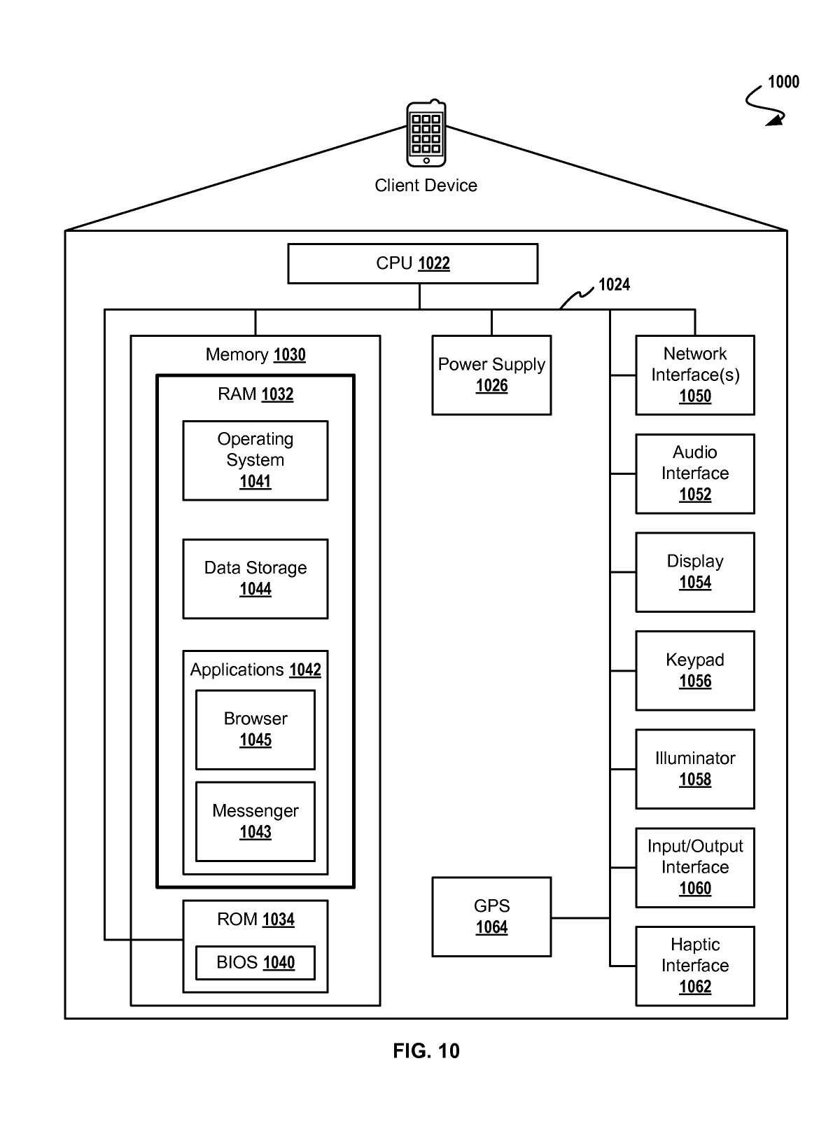

FIG. 10 is a schematic diagram illustrating an example embodiment of a client device. A client device 1000 may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric or other instance of a keypad 1056 or a display 1054 of limited functionality, such as a monochrome liquid crystal display (LCD) for displaying text and symbols. In contrast, however, as another example, a web-enabled client device may include one or more physical or virtual keyboards, mass storage, one or more accelerometers, one or more gyroscopes, global positioning system (e.g., GPS 1064) or other location-identifying type capability, or a display with a high degree of functionality, such as a touch-sensitive color 2D or 3D display, possibly with backlighting or other illuminator 1058, or a haptic interface 1062, or another variety of input/output interface 1060, for example.

A client device may include memory 1030, possibly with a section of RAM 1032 or other memory (e.g., data storage 1044) or forms of non-volatile memory (e.g., ROM 1034) that can be accessed by a processor (e.g., CPU 1022) and which may execute a variety of basic I/O functions (e.g., BOS 1040) and/or may execute a variety operating systems 1041, including a personal computer operating system, such as a Windows, iOS or Linux, or a mobile operating system, such as iOS, Android, or Windows Mobile, or the like. A client device may include or may execute a variety of possible applications 1042, such as a client software application enabling communication with other devices, such as communicating one or more messages using a messenger application 1043, or such as via email, short message service (SMS), or multimedia message service (MMS), including via a network, such as a social network, including, for example, Facebook, Linkedln, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing using a browser 1045, searching, playing various forms of content, including locally stored or streamed video, audio (e.g., using audio interface 1052) or games (such as fantasy sports leagues), possibly including networked games or other applications using one or more instances of network interface 1050. Any of the foregoing functional blocks comprising the client device 1000 can be powered by one or more instances of power supply 1026, and any of the foregoing functional blocks comprising the client device 1000 can communicate with any other of the foregoing functional blocks over a communication bus 1024. The foregoing is provided to illustrate that claimed subject matter is intended to include a wide range of possible features or capabilities.

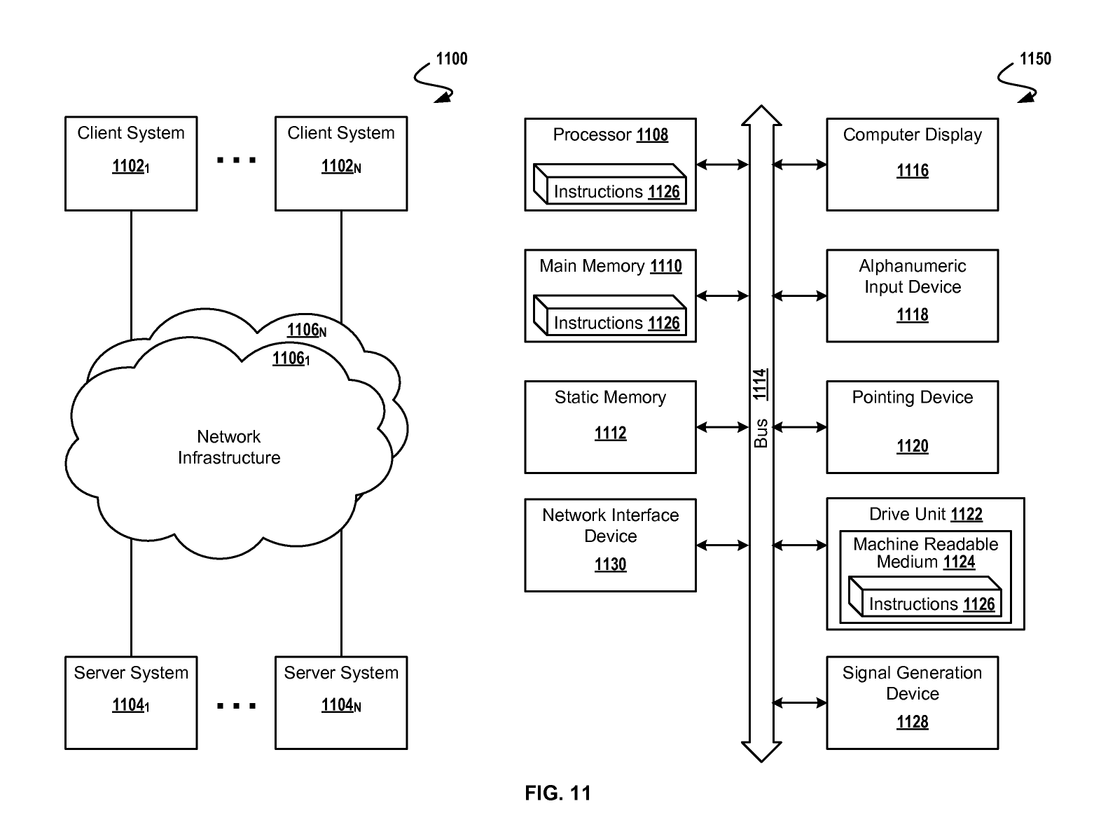

FIG. 11 is a block diagram 1100 of a computer system, for implementing embodiments. FIG. 11 depicts network of a system for using advertising campaign allocation optimization results to calculate bids, according to some embodiments. The computer system includes nodes for client computer systems 1102₁ through 1102_{N}, nodes for server computer systems 1104₁ through 1104_{N}, and nodes for network infrastructure 1106₁ through 1106_{N}, any of which nodes may comprise a machine (e.g., computer 1150) within which a set of instructions for causing the machine to perform any one of the techniques discussed above may be executed. The embodiment shown is purely exemplary, and might be implemented in the context of one or more of the figures herein

Any node of the network may comprise a general-purpose processor, a digital signal processor (DSP), an application specific integrated circuit (ASIC), a field programmable gate array (FPGA) or other programmable logic device, a discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration, etc.).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g., a client computer system, a server computer system) and/or may comprise one or more embedded computer systems (including a processor and memory), a massively parallel computer system, and/or a cloud computer system.

The computer system (e.g., computer 1150) includes a processor 1108 (e.g., a processor core, a microprocessor, a computing device, etc.), a main memory (e.g., computer memory 1110), and a static memory 1112, which communicate with each other via a system bus 1114. The computer 1150 may further include a display unit (e.g., computer display 1116) that may comprise a touch-screen, or a liquid crystal display (LCD), or a light emitting diode (LED) display, or a cathode ray tube (CRT). As shown, the computer system also includes a human input/output (I/O) device 1118 (e.g., a keyboard, an alphanumeric keypad, etc.), a pointing device 1120 (e.g., a mouse, a touch screen, etc.), a drive unit 1122 (e.g., a disk drive unit, a CD/DVD drive, a tangible computer readable removable media drive, an SSD storage device, etc.), a signal generation device 1128 (e.g., a speaker, an audio output, etc.), and a network interface device 1130 (e.g., an Ethernet interface, a wired network interface, a wireless network interface, a propagated signal interface, etc.).

The drive unit 1122 includes a machine-readable medium 1124 on which is stored a set of instructions (i.e., software, firmware, middleware, etc.) 1126 embodying any one, or all, of the methodologies described above. The set of instructions 1126 is also shown to reside, completely or at least partially, within the main memory and/or within the processor 1108. The set of instructions 1126 may further be transmitted or received via the network interface device 1130 over the system bus 1114.

It is to be understood that embodiments of this disclosure may be used as, or to support, a set of instructions executed upon some form of processing core (such as the CPU of a computer) or otherwise implemented or realized upon or within a machine- or computer-readable medium. A machine-readable medium includes any mechanism for storing non-transitory information in a form readable by a machine (e.g., a computer). For example, a machine-readable medium includes read-only memory (ROM); random access memory (RAM); magnetic disk storage media; optical storage media; flash memory devices; and electrical, optical or acoustical or any other type of media suitable for storing non-transitory information.

While the figures and description have been described with reference to numerous specific details, one of ordinary skill in the art will recognize that the claimed embodiments can be differently embodied in other specific forms without departing from the scope of the claims.

We claim:

1. A computer implemented method for using advertising campaign allocation optimization results to calculate bids, the method comprising:
receiving, by a computer, a candidate impression opportunity corresponding to an advertising campaign having at least one branding objective, and at least one performance-based objective;
using advertising campaign allocation optimization results to determine a set of matching contracts that satisfy the candidate impression;
calculating a bid for the set of the matching contracts, wherein the calculating comprises a forecast of a future occurrence of the candidate impression opportunity;
selecting a target contract from among the set of matching contracts wherein the target contract has a lowest likelihood of being satisfied by the future occurrence of the candidate impression opportunity; and
bidding, using a server, on the candidate impression opportunity using the calculated bid of the selected target contract.

2. The method of claim 1, wherein the branding objective comprises serving a minimum number of advertisements within a time duration of the advertising campaign.

3. The method of claim 1, wherein the performance-based objective comprises maximizing a return on advertising spend within a time duration of the advertising campaign.

4. The method of claim 1, further comprising tallying fulfillment of the candidate impression opportunity when the calculated bid is the winning bid.

5. The method of claim 1, wherein the advertising campaign allocation optimization results comprises optimization of advertiser ROI.

6. The method of claim 1, wherein the advertising campaign allocation optimization results comprises optimization of the ad network operator ROI.

7. The method of claim 1, wherein bidding on the candidate impression opportunity comprises a bid that is greater than a campaign-assigned value.

8. A computer system for using advertising campaign allocation optimization results to calculate bids, comprising:
a computer processor to execute a set of program code instructions; and
a memory to hold the program code instructions, in which the program code instructions comprises program code to perform,
receiving a candidate impression opportunity corresponding to an advertising campaign having at least one branding objective, and at least one performance-based objective;
using advertising campaign allocation optimization results to determine a set of matching contracts that satisfy the candidate impression;
calculating a bid for the set of the matching contracts, wherein the calculating comprises a forecast of a future occurrence of the candidate impression opportunity;
selecting a target contract from among the set of matching contracts wherein the target contract has a lowest likelihood of being satisfied by the future occurrence of the candidate impression opportunity; and
bidding on the candidate impression opportunity using the calculated bid of the selected target contract.

9. The computer system of claim 8, wherein the branding objective comprises serving a minimum number of advertisements within a time duration of the advertising campaign.

10. The computer system of claim 8, wherein the performance-based objective comprises maximizing a return on advertising spend within a time duration of the advertising campaign.

11. The computer system of claim 8, further comprising tallying fulfillment of the candidate impression opportunity when the calculated bid is the winning bid.

12. The computer system of claim 8, wherein the advertising campaign allocation optimization results comprises optimization of advertiser ROI.

13. The computer system of claim 8, wherein the advertising campaign allocation optimization results comprises optimization of the ad network operator ROI.

14. The computer system of claim 8, wherein bidding on the candidate impression opportunity comprises a bid that is greater than a campaign-assigned value.

15. A computer program product embodied in a non-transitory computer readable medium, the computer readable medium having stored thereon a sequence of instructions which, when executed by a processor causes the processor to execute a method to implement advertising campaign allocation optimization results to calculate bids, the method comprising:
receiving a candidate impression opportunity corresponding to an advertising campaign having at least one branding objective, and at least one performance-based objective;
using advertising campaign allocation optimization results to determine a set of matching contracts that satisfy the candidate impression;
calculating a bid for the set of the matching contracts, wherein the calculating comprises a forecast of a future occurrence of the candidate impression opportunity;
selecting a target contract from among the set of matching contracts wherein the target contract has a lowest likelihood of being satisfied by the future occurrence of the candidate impression opportunity; and
bidding on the candidate impression opportunity using the calculated bid of the selected target contract.

16. The computer program product of claim 15, wherein the branding objective comprises serving a minimum number of advertisements within a time duration of the advertising campaign.

17. The computer program product of claim 15, wherein the performance-based objective comprises maximizing a return on advertising spend within a time duration of the advertising campaign.

18. The computer program product of claim 15, further comprising tallying fulfillment of the candidate impression opportunity when the calculated bid is the winning bid.

19. The computer program product of claim 15, wherein the advertising campaign allocation optimization results comprises optimization of advertiser ROI.

20. The computer program product of claim 15, wherein the advertising campaign allocation optimization results comprises optimization of the ad network operator ROI.
